(19) United States
(12) Patent Application Publication
(10) Pub. No.: US 2004/0098598 A1
(43) Pub. Date: May 20, 2004

(54) Device for the control functions by means of biometric data

(75) Inventor: Peter Wolfram, Hoflein (AT)

Correspondence Address: D Douglas Price, Steptoe & Johnson, 1330 Connecticut Avenue NW, Washington, DC, 20036, US

(73) Assignee: INTERBIOMETRICS ZUGANGSSYSTEME GMBH, Bruckneudorf (AT)

(21) Appl. No.: 10/399,912

(22) PCT Filed: Oct. 10, 2001
(86) PCT No.: PCT/AT01/00325

(30) Foreign Application Priority Data
Nov. 3, 2000 (AT) GM 806/2000

(51) Int. Cl. H04L 9/00; H04K 1/00

(52) U.S. Cl. 713/186; 380/270

(57) ABSTRACT

The invention relates to a device for the control of functions via biometric data, in particular for access control, comprising at least one camera (2) for recording biometric data, at least one memory (5) for storing biometric data of authorized persons, and a computing and controlling unit (3) with at least one interface (6) for connecting a unit (7) to be controlled, e.g. a door lock, with the at least one camera (2) being arranged in a detachable recording module (1) that is connected to the computing and controlling unit (3). To provide a handy, versatile and inexpensive device which is difficult to be manipulated, it is provided for encoding or encrypting means (26) and respective decoding and decrypting means (27) to be arranged in the recording module (1) and in the computing and controlling unit (3), or in the unit (7) to be controlled, respectively. Moreover, an identifying or authenticating unit (22) may be provided in the recording module (1) and/or in the computing and controlling unit (3).

The invention relates to a device for the control of functions via biometric data, in particular for access control, comprising at least one camera for recording biometric data, at least one memory for storing biometric data of authorized persons, and a computing and controlling unit with at least one interface for connecting a unit to be controlled, e.g. a door lock, with the at least one camera being arranged in a detachable recording module that is connected to the computing and controlling unit.

Persons can unambiguously be identified by biometric data, such as face, lip movements, iris or finger prints. Therefore, these data are particularly suitable for a person-related control of functions, such as, e.g., access controls, immobilizers for motor vehicles or the like. In contrast to conventional methods, the entry of passwords or pin codes is not necessarily required. Thus, fraudulent use by copied passwords or codes is prevented, and on the other hand, the comfort for the authorized persons is increased by the fact that passwords or pin codes need not be remembered and, thus, cannot be forgotten either. To increase the reliability of systems for recognizing biometric data, in most instances several biometric characteristics are simultaneously recorded and evaluated. In this manner, a reliable functioning is ensured also if one of the characteristics changes, such as, e.g., the voice as a consequence of a cold, or the facial expression due to certain circumstances. Particularly the image of the face is of primary importance because of its unambiguity.

The possible fields of application of such devices for the control of functions by means of biometric data range from access controls to high-security zones, immobilizers for motor vehicles, access controls for computers or machines, time recording systems as far as to person-related adjustments, e.g. of seat positions and adjusted rearview mirror positions in motor vehicles and many others. Depending on the function to be controlled, e.g., locks, switches or the like will be appropriately controlled by the authorized persons and thus the desired function will be obtained if the biometric data registered match the biometric data stored.

A device of the present type is described e.g. in WO 98/11501 A2, which describes a device for recording the finger print, wherein the camera for recording the finger print is arranged in a detachable recording module which, e.g., can be connected to a computer via the serial interface.

WO 98/47096 A1 shows a portable device for registering and transmitting data derived from the finger print of the user, the data transmission occurring to a computing unit, preferably via infrared or high frequency.

DE 295 04 660 U1 describes an arrangement for access control in which the facial characteristics are recorded with the help of a camera and the voice with the help of a microphone, and wherein certain functions are controlled if characteristic parameters match the stored parameters of authorized persons. Since the imaging of faces often poses problems due to the influences of extraneous light, a filter is arranged in front of the camera so as to suppress extraneous light.

One possible way of controlling access to a computer is, e.g., provided by a computer mouse with a finger sensor arranged thereon as described in WO 00/38096 A1 as well as in WO 00/38105 A1.

EP 1 031 479 A2 describes a biometric sensor for motor vehicles which registers biometric characteristics of a person, such as finger prints, and unlocks doors or overrides the ignition lock if they match with the stored biometric characteristics.

Many of the known systems for access control or the like via biometric data are very voluminous and not adaptable to different fields of application. Also the costs of currently available devices of the above-indicated type in most cases are comparatively high and thus do not yet allow for a broad application, in particular on the private sector. Moreover, the known systems for an access control or the like are unsafe so that their application is limited to certain fields of use.

Therefore, the present invention has as its object to provide a device for the control of functions via biometric data, which is handy, versatile in its use and inexpensive to produce. Moreover, the device is to be as safe as possible and not easy to circumvent or to manipulate. Disadvantages of known devices are to be avoided or at least reduced.

The object according to the invention is achieved in that in the recording module and in the computing and controlling unit, or in the unit to be controlled, respectively, encoding or encrypting means and corresponding decoding and decrypting means are arranged. By the modular and detachable construction of the recording module, the latter can be made very small and set up at the desired location in a versatile manner. The computing and controlling unit may be formed by a personal computer or a microprocessor or the like. Moreover, several recording modules can be connected with the computing and controlling unit. This further adds to the versatility. By arranging an encoding or encrypting means in the recording module as well as a corresponding decoding and decrypting means in the computing and controlling unit, or in the unit to be controlled, respectively, a greater safety, in particular in the transmission of the data between the recording modules and the computing and controlling unit, or the unit to be controlled, or between the computing and controlling unit and the unit to be controlled, respectively, can be achieved. Likewise, by such an encoding and decoding means also a compression of the data and thus, a more efficient transmission between the recording module and the computing and controlling unit can be effected, which is particularly important in case of large distances. By encrypting the data it is prevented that the connection between the recording module and the computing and controlling unit can be separated and, e.g., a video signal from a video recording of the authorized person can be inserted so that unauthorized persons could, e.g., get access to a high-security area.

In this case, the connection between the or each recording module and the computing and controlling unit can be effected via plug-in contacts, cables, or in a wireless manner, e.g. via infrared or high frequency means. The distance to be bridged between the or each recording module and the computing and controlling unit may, in principle, be arbitrary. When transmitting the relevant data, e.g. via high frequency, practically any distances can be bridged. In this manner, a transmission can be effected by utilizing mobile telephone networks or the like. In case of a wireless connection, the required transmitting and receiving installations must, of course, be provided both in the recording module and in the computing and controlling unit. Moreover, a separate voltage supply is required in the recording module, which voltage supply may also be formed by respective solar cells or the like.

Advantageously, light sources, in particular infrared light sources, are provided in the recording module for illuminating the field of vision of the at least one camera. In this case, e.g. infrared light diodes are arranged in a circle around the camera. By using special light sources, also a fraudulent use of the device by means of a picture, e.g. a photograph of the person whose access is authorized, can effectively be prevented. By a camera which is sensitive in the infrared range also the thermal radiation of the person can be sensed, whereby a picture of the authorized person which does not emit a thermal radiation would be identified as fake.

Likewise, at least one light source can be provided in the recording module for emitting visible light to attract the attention of the person to be detected so that the face and the corresponding biometric data can effectively be recorded.

For the same purpose, however, also at least one loudspeaker or an interface for a loudspeaker can be provided in the recording module. By a respective signaling or a voice message, the person to be recorded can be caused to look at the camera. Via such a loudspeaker, however, also other messages can be issued, e.g. to assist in the directing of the user.

To record the voice of the person to be recorded, at least one microphone or an interface for a microphone is provided in the recording module.

To suppress background noise, a filter can be provided in the recording module, which advantageously functions via a second microphone for recording the background noises.

For an optic display of information or for directing the user, at least one display or an interface for connecting a display can be provided in the recording module. The display may be a numeric or alphanumeric display or screens, e.g. LCD or TFT monitors. To obtain further functions, an identifying or authenticating unit or an interface for connecting an identifying or authenticating unit may be provided in the recording module and/or in the computing and controlling unit. With the assistance of such an identifying or authenticating unit which, e.g. may be formed by a card reader or the like, the safety may be further increased or the possible fields of use can be enlarged. For instance, the authorized person may possess a magnetic card or the like in which an additional code as well as a biometric data set is stored. In this manner, the control of the functions via biometric data will only be possible if the authorized person is identified as such and, moreover, the additional code is viewed as authorized. By this method, also high-security areas can effectively be protected. Moreover, in this manner e.g. an installation for controlling an ATM can be created, wherein the respective credit card or bank card is inserted and an identification of the person will be effected not, as usual, via entry of a pin code, but via the biometric data of the person.

To sense the approach of a person, advantageously an approach sensor or an interface for an approach sensor is provided in the recording module. Thus, the camera can automatically be activated if a person approaches it.

To protect the at least one camera and the optional light source, a protective glass pane or the like is arranged in front of the at least one camera and/or in front of the or each light source.

To attract a person's attention and to allow for a self-check of the person to be recorded, a mirror or a reflecting surface can be arranged behind the at least one camera and/or behind the or each light source.

To allow for a manual activation or input of certain information, an operating switch, a keyboard or the like can be provided in the recording module and/or in the computing and controlling unit. For instance, the functioning of the device can be initiated by actuation of an operating switch.

If a memory is provided in the recording module, biometric data can be stored already in the recording module. The memory may, however, also be used to store program sequences for directing the user or the like.

If a computer, in particular a microprocessor, is additionally arranged in the recording module, a comparison of the recorded biometric data with the biometric data stored can already be effected in the recording module.

If the computing and controlling unit contains at least one memory for storing biometric data of authorized persons, the comparison of the biometric data may be effected in this computing and controlling unit.

As an alternative or in addition thereto, the computing and controlling unit can also be connectable to a central computer with at least one memory for storing biometric data of authorized persons, and thus, the comparison of the relevant data may be effected outside of the computing and controlling unit in a central computer. In this instance, the computing and controlling unit represents a client, and the central computer represents the server, and thus several computing and controlling units can be arranged in a central computer in a network structure.

The characteristics of the present invention will now be explained in more detail by way of the enclosed figures. Therein,

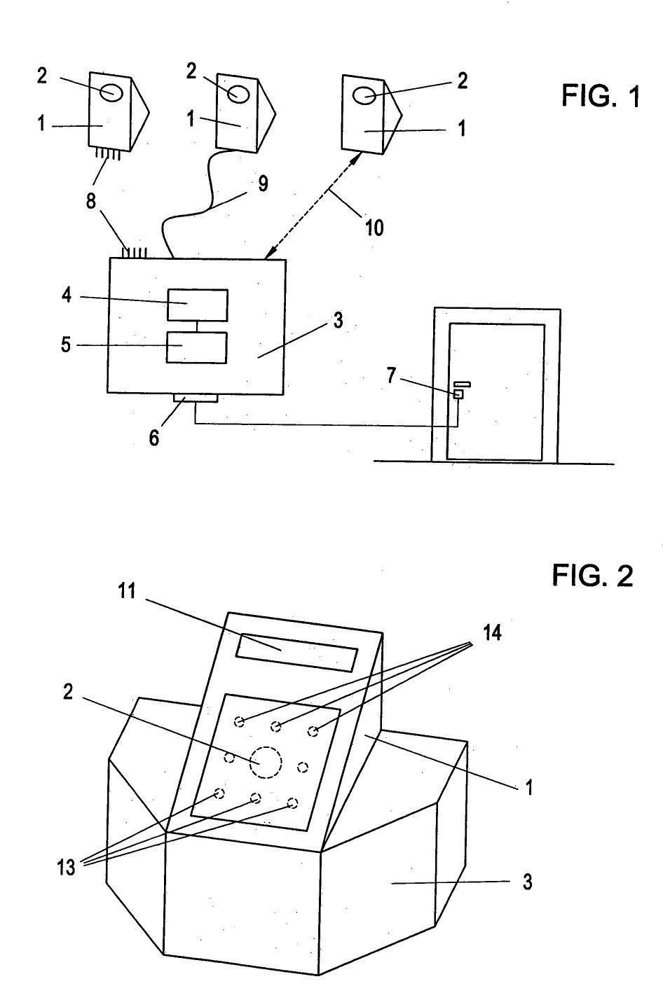

FIG. 1 shows a block diagram of the arrangement according to the invention;

FIG. 2 shows an embodiment of the arrangement according to the invention in a perspective view; and

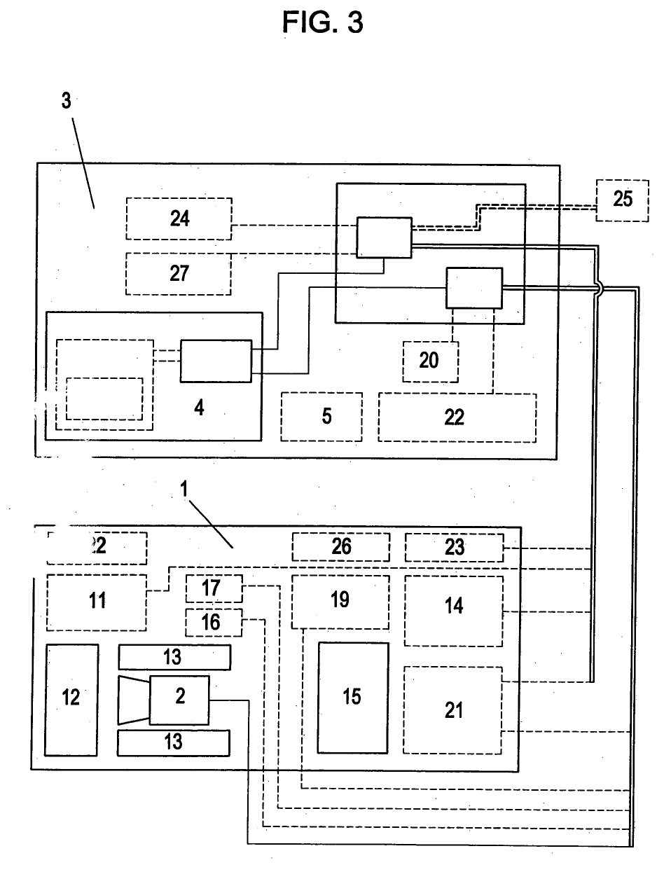

FIG. 3 shows a block diagram of the entire arrangement.

FIG. 1 shows the device for controlling functions via biometric data, comprising at least one recording module 1, in which at least one camera 2 is arranged for recording the biometric data. The camera 2 advantageously is a very small unit, e.g. a CCD (charged coupled device) image converter with appropriate optics. The recording module 1 is arranged so as to be detachable from the computing and controlling unit 3 which comprises a computer 4, a memory 5 and at least one interface 6 for a connection to the unit 7 to be controlled, e.g. a door lock. The detachability of the recording module 1 from the computing and controlling unit 3 can be effected by plug-in contacts 8, it being possible for the recording module 1 to be directly arranged on the computing and controlling unit 3, or to be placed at an appropriate distance from the computing and controlling unit 3 by appropriate connecting cables 9. The connection between the recording module 1 and the computing and controlling unit 3 may also be wireless, e.g. via an infrared or high frequency connection 10. For this purpose, the respective transmitters and receivers are required in the recording module 1 and in the computing and controlling unit 3. By utilizing a common communication method, e.g. a mobile phone network, very large distances between recording module 1 and the computing and controlling unit 3 can be bridged. This may, however, also be effected via other radio connections. Moreover, also the data connection via data networks, such as, e.g., the Internet, is possible. The interface between the recording module 1 and the computing and controlling unit 3 may be formed by a conventional interface, such as, e.g., the bus system designed for the periphery of a computer USB (Universal Serial Bus), or serial or parallel computer interfaces. To obtain, e.g., access to a door, the person stands in front of the respective recording module 1 and looks into the camera 2, whereupon corresponding images of the face or also the finger print of the person are recorded. The data are transmitted via the plug-in contacts 8, the cable 9 or the connection 10 to the computing and controlling unit 3, where the respective characteristic biometric data are determined by the computer 4 from the image data and compared with the characteristic biometric data of authorized persons stored in a memory. If the biometric data of the person match the stored biometric data, the unit 7 to be controlled, e.g. the door lock, will be unlocked via interface 6. In addition, a positive report may be sent to the recording module 1. If the biometric data of the person do not match the biometric data stored in memory 5, the unit 7 to be controlled, e.g. the door lock, will not be activated, and optionally an error report is sent to the recording module 1. To prevent a fraudulent use of the system or at least make it difficult, an encoding or encrypting means 25 and a corresponding decoding and decrypting means are arranged in the recording module 1 and in the computing and controlling unit 3, and in the unit 7 to be controlled, respectively, e.g. the door lock (cf. FIG. 3).

FIG. 2 shows an embodiment of the invention in a perspective view. The recording module 1 comprises a camera 2 which, advantageously, is arranged behind a protective glass pane 12. Light sources 13, in particular infrared light sources, may be provided around the camera 2 so as to illuminate the field of vision of camera 2. Moreover, also light sources 14 may be provided in the vicinity of camera 2 to emit visible light by which the attention of a person to be recorded can be attracted. Moreover, a display or an interface for a display 11 may be provided in the recording module 1. The recording module 1 can be connected to the computing and controlling unit 2 via respective, above-described possible means. The computing and controlling unit 3 may be built up by a commercially available personal computer or also by a microcomputer.

FIG. 3 shows a block diagram of an inventive device for controlling functions via biometric data. The recording module 1 comprises at least one camera 2 around which light sources 13, in particular sources of infrared light, may be arranged so as to illuminate the field of vision of camera 2. Advantageously, the camera 2 and the infrared light sources 13 are arranged behind a protective glass pane 12. A semi-transparent mirror usually arranged in front of the camera 2 is avoided because the light yielded would be reduced too much. Instead, a mirror 15 or a reflecting surface may be provided behind the camera 2 and the light sources 13, which mirror or reflecting surface serves to attract attention and to allow for a self-check of the person. To attract the attention of the person in front of the camera 2, a light source 14 for emitting visible light may serve. Also a loudspeaker 16 may serve for this purpose which emits a respective acoustic signal. Via such a loudspeaker 16, also instructions can be given. To record the voice of the person to be recorded, yet also to receive questions or the like, advantageously a microphone 17 is arranged in the recording module 1 or connected thereto via an appropriate interface. To suppress background noises, a filter may be provided in the recording module 1 which separates the background noises recorded by a second microphone from the useful signal recorded by microphone 17 (not illustrated). This filter may, however, also be arranged in the computing and controlling unit 3, or it may be realized by the computer 4 provided in the computing and controlling unit 3. In order to provide information or to direct the user, a display 11 may be provided in the recording module 1 or may be connected thereto via an appropriate interface. The display 11 may be a single-line or multi-line display or a screen. For an optional operation, an operating key, a keyboard or the like, may be provided in the recording module 1 and/or in the computing and controlling unit 3. In the recording module 1, a memory 21 may be arranged so as to store biometric data of authorized persons or also to store program sequences for directing the user, or the like. If, e.g., calculations of biometric data are to be computed in the recording module 1 from the images recorded by camera 2, or a comparison with stored biometric data is to be effected, a computer, in particular a microprocessor (not illustrated), advantageously will be arranged in the recording module 1. For further functions, an identifying or authenticating unit 22 may be provided in the recording module 1 and/or in the computing and controlling unit 3, or connected thereto via an appropriate interface. Via such an identifying or authenticating unit which, e.g., is designed as a card reader 22, the function of a cash dispenser (ATM) may, e.g., be realized. Furthermore, with such an identifying or authenticating unit 22 the safety can be further increased since in addition to the biometric data also a further code must be presented by the authorized person. With such an identifying or authenticating unit 22, a unique encoding or encryption of the data can be effected during the transmission between recording module 1 and computing and controlling unit 3, and between the unit 7 to be controlled, respectively. The authorized person may, e.g., possess a module or a chip card or the like which he/she puts into the identifying or authenticating unit 22 in recording module 1 in a contacting or contact-free mode, and in this manner proves his/her authorization. To sense the approach of a person to be recorded, advantageously an approach sensor 23 is arranged in the recording module 1 or connected thereto via a respective interface. To operate the computing and controlling unit 3 and to provide information, a display or a screen 24 is provided in the computing and controlling unit 3. To store biometric data of authorized persons, a memory 5 may serve in the computing and controlling unit 3. Alternatively, the data of authorized persons may also be provided in a memory of a central computer 25 which is connected with the computing and controlling unit 3 via an appropriate connection. The connection between the computing and controlling unit 3 and the central computer 25 may be effected by utilizing available media, such as, e.g., the Internet. Advantageously, several computing and controlling units 3 are connected to such a central computer 25. To enhance the safety of the transmitted data, appropriate encoding and encrypting means and decoding and decrypting means can be arranged in the recording module 1, in the computing and controlling unit 3, as well as in the central computer 25 (not illustrated).

1. A device for the control of functions via biometric data, in particular for access control, comprising at least one camera (2) for recording biometric data, at least one memory (5) for storing biometric data of authorized persons, and a computing and controlling unit (3) with at least one interface (6) for connecting a unit (7) to be controlled, e.g. a door lock, with the at least one camera (2) being arranged in a detachable recording module (1) that is connected to the computing and controlling unit (3), and with encoding or encrypting means (26) and corresponding decoding and decrypting means (27) being arranged in the recording module (1) and in the computing and controlling unit (3), or in the unit (7) to be controlled, respectively, characterized in that a computer, in particular a microprocessor is provided in the recording module (1), and that an identifying or authenticating unit (22) is provided in the recording module (1) and in the computing and controlling unit (3).

2. A device according to claim 1, characterized in that the recording module (1) is connected with the computing and controlling unit (3) via plug-in contacts (8).

3. A device according to claim 1, characterized in that the recording module (1) is connected to the computing and controlling unit (3) via cables (9).

4. A device according to claim 1, characterized in that the recording module (1) is connected to the computing and controlling unit (3) in a wireless manner, e.g. via infrared or high frequency.

5. A device according to any one of claims 1 to 4, characterized in that light sources (13), in particular infrared light sources, are provided in the recording module (1) for illuminating the field of vision of the at least one camera (2).

6. A device according to any one of claims 1 to 5, characterized in that at least one light source (14) is provided in the recording module (1) to attract the attention of a person to be registered.

7. A device according to any one of claims 1 to 6, characterized in that at least one loudspeaker (16) or an interface for a loudspeaker (16) is provided in the recording module (1).

8. A device according to any one of claims 1 to 7, characterized in that at least one microphone (17) or an interface for a microphone (17) is provided in the recording module (1).

9. A device according to claim 8, characterized in that a filter for suppressing background noises is provided in the recording module (1).

10. A device according to any one of claims 1 to 9, characterized in that at least one display (18) or an interface for a display (18) is provided in the recording module (1).

11. A device according to any one of claims 1 to 10, characterized in that an approach sensor (23) or an interface for an approach sensor (23) is provided in the recording module (1).

12. A device according to any one of claims 1 to 11, characterized in that in front of the at least one camera (2) and/or in front of the or each light source (13, 14) a protective glass pane (12) or the like is provided.

13. A device according to any one of claims 1 to 12, characterized in that behind the at least one camera (2) and/or behind the or each light source (13, 14) a mirror (15) or a reflecting surface is arranged.

14. A device according to any one of claims 1 to 13, characterized in that an operating key, a keyboard (19, 20) or the like is provided in the recording module (1) and/or in the computing and controlling unit (3).

15. A device according to any one of claims 1 to 14, characterized in that a memory (21) is arranged in the recording module (1).

16. A device according to any one of claims 1 to 15, characterized in that the computing and controlling unit (3) comprises at least one memory (5) for storing biometric data of authorized persons.

17. A device according to any one of claims 1 to 16, characterized in that the computing and controlling unit (3) is connectable to a central computer (25) with at least one memory for storing biometric data of authorized persons.
